(19) United States
(12) Patent Application Publication
(10) Pub. No.: US 2026/0267131 A1
(43) Pub. Date: Sep. 10, 2026

(54) TELESCOPIC SIGHT WITH NIGHT VISION FUNCTION

(71) Applicant: SHENZHEN DISCOVERYOPT TECHNOLOGY CO., LTD, Shenzhen (CN)

(72) Inventor: Xinjian Guo, Shenzhen (CN)

(21) Appl. No.: 19/658,513

(22) Filed: Apr. 25, 2026

(30) Foreign Application Priority Data
Jan. 22, 2026 (CN) 202620083951.8

(51) Int. Cl. G02B 23/12; G02B 23/04; G02B 23/10; G02B 23/16

(52) U.S. Cl. CPC G02B 23/12; G02B 23/04; G02B 23/105; G02B 23/16

(57) ABSTRACT

Disclosed in this disclosure is a telescopic sight with a night vision function, including: a white light telescopic sight body; a beam splitting member, where the beam splitting member is disposed at a second focal plane of the white light telescopic sight body; and a night vision assembly, where the night vision assembly is connected to the white light telescopic sight body and is disposed adjacent to the beam splitting member, and the beam splitting member is configured to reflect electromagnetic waves with wavelengths greater than or equal to 780 nm to a sensor of the night vision assembly and allow electromagnetic waves with other wavelengths to pass through the beam splitting member. The beam splitting member includes a light-transmitting carrier and a reflection layer disposed on the light-transmitting carrier; and the reflection layer is disposed obliquely.

### TECHNICAL FIELD

This disclosure relates to the technical field of sight equipment, and specifically to a telescopic sight with a night vision function.

### BACKGROUND

Optical telescopic sights, also known as white light telescopic sights, are generally only suitable for assisting shooting equipment in observing and aiming at targets in daylight or well-lit environments. However, in low-light environments at night, it becomes difficult to see the targets clearly using optical telescopic sights. Therefore, in the prior art, additional night vision devices are used for cooperation.

Currently, in a low-light-level night vision telescopic sight disclosed in the patent with application No. 201821195410.6, by disposing a beam splitter in the telescopic sight, the night vision device and the telescopic sight are combined together. This avoids the problem that the mounting position of shooting equipment can only be set up with either a traditional night vision device or a telescopic sight, which requires repeated mounting. However, the low-light-level night vision telescopic sight disclosed in this patent employs basic thinking: simply diverting the light that enters the tube of the telescopic sight and reaches the beam splitter to the night vision apparatus according to light intensity. Although the light intake requirements of the night vision equipment are met, when the user observes a target with the naked eyes using the ocular lens of the white light telescopic scope in the daytime environment, since a portion of the light intensity is diverted, the clarity is significantly compromised compared to that of the conventional white light telescopic scope when observing the target. Consequently, this technical solution fails to achieve the expected effects, thereby precluding the product from being launched into the market.

### SUMMARY

In view of the above problems, this disclosure mainly provides a telescopic sight with a night vision function, aiming to solve the technical problems in the background.

To achieve the above purpose, this disclosure provides a telescopic sight with a night vision function, including:

a white light telescopic sight body;

a beam splitting member, where the beam splitting member is disposed at a second focal plane of the white light telescopic sight body; and

a night vision assembly, where the night vision assembly is connected to the white light telescopic sight body and is disposed adjacent to the beam splitting member, and the beam splitting member is configured to reflect electromagnetic waves with wavelengths greater than or equal to 780 nm to a sensor of the night vision assembly and allow electromagnetic waves with other wavelengths to pass through the beam splitting member.

Further, the beam splitting member includes a light-transmitting carrier and a reflection layer disposed on the light-transmitting carrier; and the reflection layer is disposed obliquely.

Further, the light-transmitting carrier includes a first triangular prism and a second triangular prism; inclined surfaces of the first triangular prism and the second triangular prism are connected in an attached manner; and the reflection layer is disposed at an attached position between the inclined surfaces of the first triangular prism and the second triangular prism.

Further, the light-transmitting carrier is a lens body, and the lens body is disposed obliquely.

Further, an inclined angle of the reflection layer is 45°.

Further, a tube wall of a tube of the white light telescopic sight body is provided with a mounting groove corresponding to the night vision assembly.

Further, the reflection layer is configured to reflect electromagnetic waves with wavelengths of 800 nm to 870 nm and above entering from an objective lens of the white light telescopic sight body to the sensor of the night vision assembly.

Further, the beam splitting member is provided with an anti-reflection layer.

Further, the night vision assembly includes a laser light compensator, and the laser light compensator is configured to emit electromagnetic waves with wavelengths of 840 nm to 950 nm for light compensation.

Further, the reflection layer is configured to reflect electromagnetic waves with wavelengths of 700 nm to 1100 nm and above entering from an objective lens of the white light telescopic sight body to the sensor of the night vision assembly.

Compared with the prior art, the telescopic sight with a night vision function provided in this disclosure can only reflect the electromagnetic waves with wavelengths greater than or equal to 780 nm to the sensor of the night vision assembly through the beam splitting member, while the electromagnetic waves with wavelengths between 780 nm and 380 nm still pass through the beam splitting member with virtually no perception, attenuation, or obstruction, subsequently traveling through the ocular lens to reach the eyes of the user. Consequently, even with the beam splitting member positioned ahead of the ocular lens, there is no interference with the intensity of the visible light perceived by the human eyes. Thus, in daytime environments, the user can directly use the inherent optical working functions of the white light telescopic sight without removing the night vision assembly and the beam splitting member from the white light telescopic sight body, without any loss of pixel clarity.

### BRIEF DESCRIPTION OF THE DRAWINGS

FIG. 1 is a schematic structural diagram of a telescopic sight with a night vision function according to this disclosure;

FIG. 2 is a schematic sectional view of Embodiment 1 of a telescopic sight with a night vision function according to this disclosure;

FIG. 3 is a schematic structural diagram of Embodiment 2 of a telescopic sight with a night vision function according to this disclosure;

FIG. 4 is a schematic structural diagram of a layout of Embodiment 1 and a sensor of a telescopic sight with a night vision function according to this disclosure;

FIG. 5 is a schematic structural diagram of a layout of Embodiment 2 and a sensor of a telescopic sight with a night vision function according to this disclosure; and

FIG. 6 is a schematic diagram of light propagation in Embodiment 1 with exploded structures of a telescopic sight with a night vision function according to this disclosure.

Reference numerals in the figures: 1. white light telescopic sight body; 110. ocular lens; 120. objective lens; 130. mounting groove; 2. beam splitting member; 210. first triangular prism; 211. light incident surface; 212. first reflection surface; 220. second triangular prism; 221. light exit surface; 222. second reflection surface; 230. lens body; 3. night vision assembly; 310. sensor.

### DETAILED DESCRIPTION OF THE EMBODIMENTS

The following clearly and completely describes the technical solutions in the embodiments of this disclosure with reference to the accompanying drawings in the embodiments of this disclosure. Apparently, the described embodiments are only some rather than all of the embodiments of this disclosure. All other embodiments obtained by those of ordinary skill in the art based on the embodiments of this disclosure without creative efforts shall fall within the protection scope of this disclosure. It may be understood that the accompanying drawings are provided for reference and explanation only and are not intended to limit this disclosure. The connection relationship shown in the accompanying drawings is only for the convenience of a clear description and does not limit the connection method.

It should be noted that when an assembly is referred to as being “connected” to another assembly, it may be directly connected to the another assembly, or there may be a centered assembly at the same time. Unless otherwise defined, all technical and scientific terms used herein have the same meanings as those commonly understood by those skilled in the art of this disclosure. It should be further noted that unless otherwise explicitly specified and limited, the terms “mount”, “interconnect”, and “connect” should be understood in a broad sense. For example, such terms may indicate a fixed connection, a detachable connection, or an integral connection; and may indicate a mechanical connection, an electrical connection, or internal communication between two elements. For those of ordinary skill in the art, the specific meanings of the above terms in this disclosure can be construed according to specific cases. The terms used in the specification of this disclosure are only intended to describe embodiments rather than to limit this disclosure.

It should be further noted that in the description of this disclosure, the orientations or positional relationships indicated by the terms “center”, “up”, “down”, “left”, “right”, “vertical”, “horizontal”, “inside”, “outside”, and the like are based on those shown in the accompanying drawings, intended only for the convenience of describing this disclosure and for simplifying the description, and not intended to indicate or imply that the referred device or element must be provided with a particular orientation or constructed and operated with a particular orientation, therefore not allowed to be construed as a limitation of this disclosure. Furthermore, the terms “first”, “second”, and “third” are used for descriptive purposes only and not allowed to be construed as an indication or implication of relative importance.

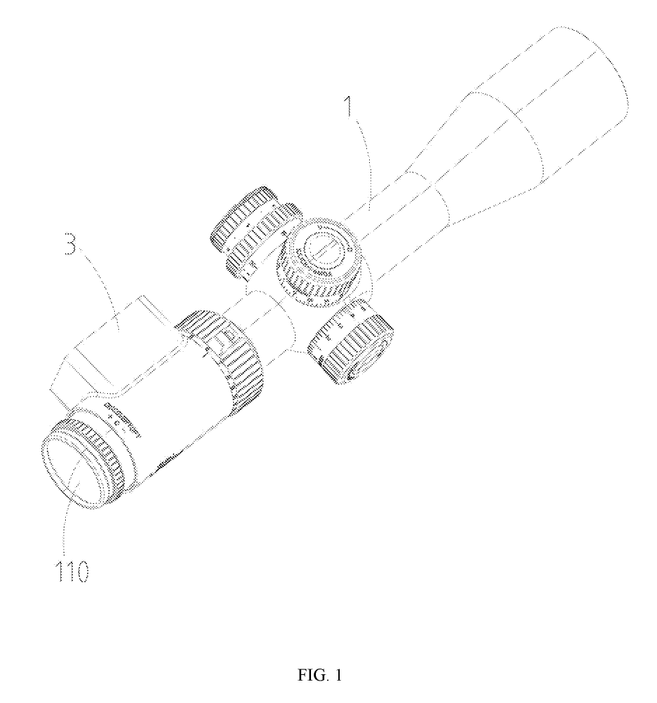

Referring to FIG. 1 to FIG. 5, this embodiment provides a telescopic sight with a night vision function, including:

a white light telescopic sight body 1;

a beam splitting member 2, where the beam splitting member 2 is disposed at a second focal plane of the white light telescopic sight body 1; and

a night vision assembly 3, where the night vision assembly 3 is connected to the white light telescopic sight body 1 and is disposed adjacent to the beam splitting member 2, and the beam splitting member 2 is configured to reflect electromagnetic waves with wavelengths greater than or equal to 780 nm to a sensor 310 of the night vision assembly 3 and allow electromagnetic waves with other wavelengths to pass through the beam splitting member 2.

In the prior art, through a beam splitter, light entering an objective lens of the white light telescopic sight body 1 is reflected and allocated to a night vision device according to light intensity. Therefore, when a user observes a target with naked eyes using an ocular lens of the white light telescopic sight in a daytime environment, since a portion of the light intensity is diverted, only about 80% of the original axial light intensity remains compared to the conventional white light telescopic sight when observing the target, and the clarity is significantly compromised. This is a result of technical inertia within this field.

However, in this disclosure, by leveraging the characteristic that electromagnetic waves perceptible to human eyes have wavelengths between 780 nm and 380 nm, only electromagnetic waves with wavelengths greater than or equal to 780 nm are reflected to the sensor 310 of the night vision assembly 3 through the beam splitting member 2, and electromagnetic waves with wavelengths between 780 nm and 380 nm still pass through the beam splitting member 2 with virtually no perception, attenuation, or obstruction, subsequently traveling through the ocular lens 110 to reach the eyes of the user. Consequently, even with the beam splitting member 2 positioned ahead of the ocular lens 110, there is no interference with the intensity of the visible light perceived by the human eyes. Thus, in daytime environments, the user can directly use the inherent optical working functions of the white light telescopic sight without removing the night vision assembly 3 and the beam splitting member 2 from the white light telescopic sight body 1, without any loss of pixel clarity.

However, in a nighttime environment, the night vision assembly 3 is started, and the sensor 310 converts electromagnetic wave signals that are reflected by the beam splitting member 2 and that are greater than or equal to 780 nm (though imperceptible to the human eyes) into digital signals through a processor and processing program to be displayed on a screen of the night vision assembly 3 for use as the night vision device, facilitating the use of the sight equipment by the user during nighttime. This is equivalent to the white light telescopic sight body 1 sharing the objective lens with the night vision assembly 3, which is ingeniously designed.

Therefore, the telescopic sight with a night vision function provided by this disclosure has high clarity during daytime use compared with similar products in the prior art and avoids the inconvenience associated with repeated disassembly, replacement, and recalibration compared with the night vision device and the telescopic sight that are two independent products.

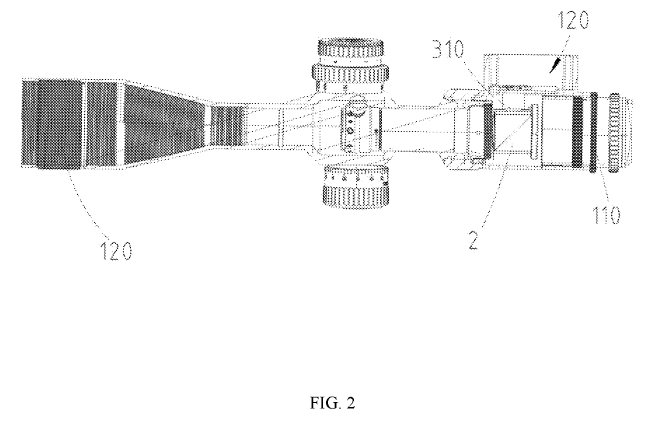

Referring to FIG. 2 to FIG. 4, the beam splitting member 2 includes a light-transmitting carrier and a reflection layer disposed on the light-transmitting carrier; and the reflection layer is disposed obliquely.

The light-transmitting carrier, on the one hand, is configured to erect the reflection layer, and on the other hand, is configured to adjust a reflection imaging direction.

If an image displayed on the screen of the night vision assembly 3 is inverted up and down, a software program built in the night vision assembly 3 may also be used for rotating a direction of the image.

The reflection layer may be connected to the light-transmitting carrier in a manner of coating or attachment.

The reflection layer that is disposed obliquely is used for adjusting a propagation direction of the electromagnetic waves with wavelengths greater than or equal to 780 nm, thereby transmitting the electromagnetic waves of this parameter to the sensor 310 of the night vision assembly 3, because the sensor 310 cannot be disposed at a position that obstructs the line of sight in a tube. However, the electromagnetic waves with wavelengths between 780 nm and 380 nm directly pass through the reflection layer and continue to pass through the ocular lens 110 to reach the eyes of the user.

In some embodiments, the reflection layer is used as a beam splitting surface, which is a coating material modulated by titanium and silicon.

### Embodiment 1

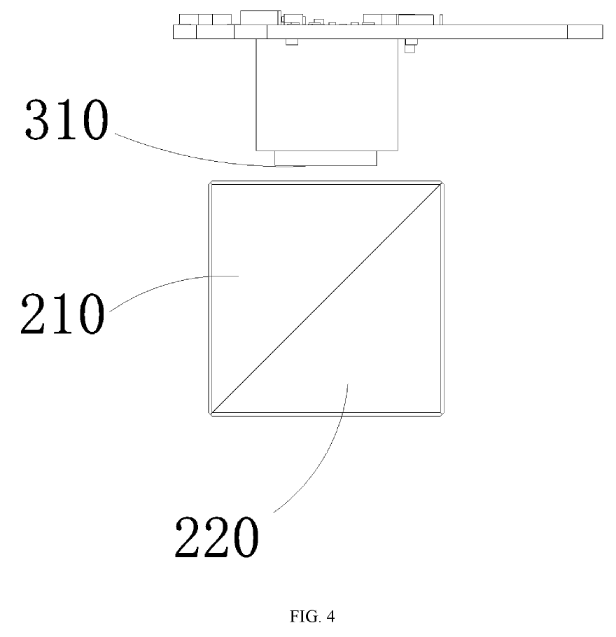

Referring to FIG. 2 and FIG. 4, the light-transmitting carrier includes a first triangular prism 210 and a second triangular prism 220. Inclined surfaces of the first triangular prism 210 and the second triangular prism 220 are connected in an attached manner. The reflection layer is disposed at an attached position between the inclined surfaces of the first triangular prism 210 and the second triangular prism 220.

After the inclined surfaces of the first triangular prism 210 and the second triangular prism 220 are connected in an attached manner, a rectangle is formed. The reflection layer may be disposed at an interface between the inclined surfaces or disposed on the inclined surface of the first triangular prism 210 or the inclined surface of the second triangular prism 220.

In some embodiments, cross sections of the first triangular prism 210 and the second triangular prism 220 are isosceles triangles.

### Embodiment 2

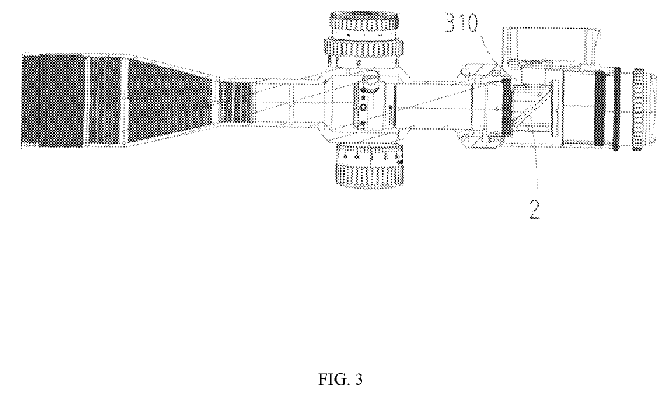

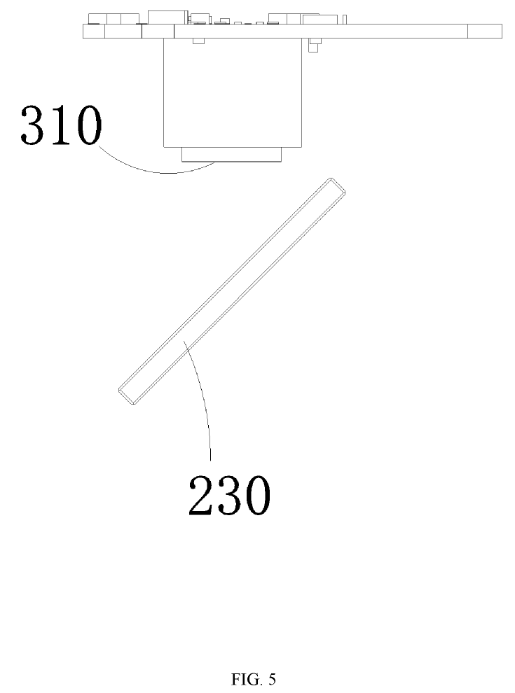

Referring to FIG. 3 and FIG. 5, the light-transmitting carrier is a lens body 230, and the lens body 230 is disposed obliquely.

The lens body 230 is directly used as a layer of lens, which may be a glass sheet body disposed at a second focal plane obliquely. The reflection layer is disposed on the lens body 230 in a manner of coating or attachment. Since the lens body 230 is disposed obliquely, and the reflection layer is inclined, the reflected electromagnetic waves reach the sensor 310.

Preferably, an inclined angle of the reflection layer is 45°.

Referring to FIG. 2 and FIG. 3, a tube wall of a tube of the white light telescopic sight body 1 is provided with a mounting groove 130 corresponding to the night vision assembly 3.

Through this arrangement, the structure on the night vision assembly 3 may be prevented from extending into the tube of the white light telescopic sight body 1 to cause interference with the field of view. In addition, a part of the housing of the night vision assembly 3 is integrally formed with the tube of the white light telescopic sight body 1, which saves material costs and reduces manufacturing and assembly procedures, facilitating production.

The groove bottom of the mounting groove 130 is provided with an avoidance through hole allowing the sensor 310 to pass through.

In some embodiments, the night vision assembly 3 may adopt a traditional layout structure in which a display screen is disposed outside the white light telescopic sight body 1.

Preferably, the reflection layer is configured to reflect electromagnetic waves with wavelengths of 800 nm to 870 nm and above entering from the objective lens 120 of the white light telescopic sight body 1 to the sensor 310 of the night vision assembly 3.

Through investigation, this solution is relatively balanced in terms of the manufacturing costs of coating on the reflection layer and the effect of converting the reflected electromagnetic waves received by the sensor 310 into a screen image.

Preferably, the beam splitting member 2 is provided with an anti-reflection layer.

By disposing an anti-reflection film, the reflection of light from the surface of the beam splitting member 2 itself is reduced, facilitating a reduction in the loss of the electromagnetic waves passing through the beam splitting member 2.

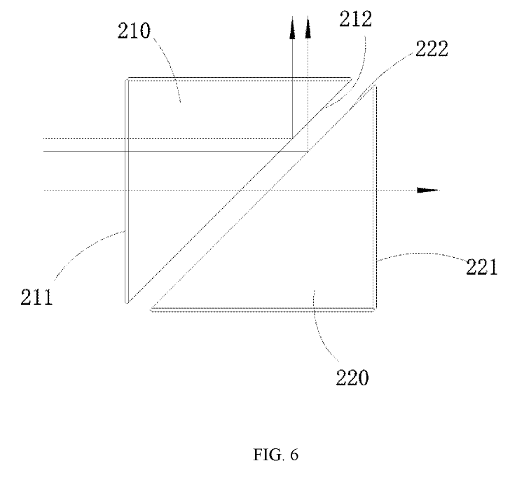

Referring to FIG. 6, a light incident surface 211 of the light-transmitting carrier composed of the two triangular prisms, that is, the first triangular prism 210 and the second triangular prism 220, is defined as a first transmitting surface, and a light exit surface 221 parallel to the light incident surface 211 is defined as a second transmitting surface. Both the first transmitting surface and the second transmitting surface are provided with the anti-reflection layers, which can reduce the reflection of electromagnetic waves ranging from 400 nm to 700 nm, facilitating a reduction in the loss of the electromagnetic waves within this range value passing through the beam splitting member 2.

Two opposite inclined surfaces of the first triangular prism 210 and the second triangular prism 220 are defined as a first reflection surface 212 and a second reflection surface 222. A reflective coating material may be disposed on either the first reflection surface 212 or the second reflection surface 222. If the reflection layer is a lamellar body itself, it may also be disposed at a joint between the first reflection surface 212 and the second reflection surface 222.

Preferably, the night vision assembly 3 includes a laser light compensator (not shown in the figure), and the laser light compensator is configured to emit electromagnetic waves with wavelengths of 840 nm to 950 nm for light compensation.

The laser light compensator may be externally disposed on an outer side of the white light telescopic sight body 1. By emitting the electromagnetic waves with wavelengths of 850 nm to 940 nm to a detection region, reflected electromagnetic waves are obtained, which are received by the sensor of the night vision assembly 3 and combined with electromagnetic waves reflected by the beam splitting member 2 to the sensor 310 for processing and imaging, further improving the imaging accuracy.

The reflection layer is configured to reflect electromagnetic waves with wavelengths of 700 nm to 1100 nm and above entering from the objective lens 120 of the white light telescopic sight body 1, and the reflected electromagnetic waves further include the reflected electromagnetic waves emitted by the laser light compensator for light compensation.

In the specification and claims of this disclosure, the words “include/comprise” and the words “have/include” and variations thereof are used for specifying the presence of stated features, values, steps, or components, but do not exclude the presence or addition of one or more other features, values, steps, components, or combinations thereof.

Some features of this disclosure are described in different embodiments for clarity of illustration. However, these features may also be described in connection with a single embodiment. On the contrary, some features of this disclosure are, for brevity, described only in a single embodiment. However, these features may also be described in different embodiments, independently or in any suitable combination.

The above descriptions are only preferred embodiments of this disclosure, and are not intended to limit this disclosure. Any modifications, equivalent replacements, improvements, and the like made within the spirit and principles of this disclosure should fall within the protection scope of this disclosure.

What is claimed is:

1. A telescopic sight with a night vision function, comprising:
a white light telescopic sight body;
a beam splitting member, wherein the beam splitting member is disposed at a second focal plane of the white light telescopic sight body; and
a night vision assembly, wherein the night vision assembly is connected to the white light telescopic sight body and is disposed adjacent to the beam splitting member, and the beam splitting member is configured to reflect electromagnetic waves with wavelengths greater than or equal to 780 nm to a sensor of the night vision assembly and allow electromagnetic waves with other wavelengths to pass through the beam splitting member.

2. The telescopic sight with a night vision function according to claim 1, wherein the beam splitting member comprises a light-transmitting carrier and a reflection layer disposed on the light-transmitting carrier; and the reflection layer is disposed obliquely.

3. The telescopic sight with a night vision function according to claim 2, wherein the light-transmitting carrier comprises a first triangular prism and a second triangular prism; inclined surfaces of the first triangular prism and the second triangular prism are connected in an attached manner; and the reflection layer is disposed at an attached position between the inclined surfaces of the first triangular prism and the second triangular prism.

4. The telescopic sight with a night vision function according to claim 2, wherein the light-transmitting carrier is a lens body, and the lens body is disposed obliquely.

5. The telescopic sight with a night vision function according to claim 1, wherein an inclined angle of the reflection layer is 45°.

6. The telescopic sight with a night vision function according to claim 1, wherein a tube wall of a tube of the white light telescopic sight body is provided with a mounting groove corresponding to the night vision assembly.

7. The telescopic sight with a night vision function according to claim 2, wherein the reflection layer is configured to reflect electromagnetic waves with wavelengths of 800 nm to 870 nm and above entering from an objective lens of the white light telescopic sight body to the sensor of the night vision assembly.

8. The telescopic sight with a night vision function according to claim 1, wherein the beam splitting member is provided with an anti-reflection layer.

9. The telescopic sight with a night vision function according to claim 1, wherein the night vision assembly comprises a laser light compensator, and the laser light compensator is configured to emit electromagnetic waves with wavelengths of 840 nm to 950 nm for light compensation.

10. The telescopic sight with a night vision function according to claim 2, wherein the reflection layer is configured to reflect electromagnetic waves with wavelengths of 700 nm to 1100 nm and above entering from an objective lens of the white light telescopic sight body to the sensor of the night vision assembly.
